(19) United States
(12) Patent Application Publication
(10) Pub. No.: US 2026/0119604 A1
(43) Pub. Date: Apr. 30, 2026

(54) TENSOR PROCESSING CIRCUITRY

(71) Applicant: Arm Limited, Cambridge (GB)

(72) Inventors: John Wakefield BROTHERS, III, Calistoga, CA (US); Jens OLSON, San Jose, CA (US); Fredrik Peter STOLT, Lund (SE)

(21) Appl. No.: 18/932,340

(22) Filed: Oct. 30, 2024

(51) Int. Cl. G06F 17/16; G06F 7/483

(52) U.S. Cl. CPC G06F 17/16; G06F 7/483

(57) ABSTRACT

There is provided tensor processing circuitry comprising a plurality of dot-product units, each of which is configured to perform a multiply accumulate operation. A format conversion unit is configured to convert the format of a first data element before processing by the plurality of dot product units. The format conversion unit is configured to convert the first data element from a first data format to one or more data elements in a second floating point data format, the first data format being one of a plurality of data formats supported by the tensor processing circuitry and the second data format being a predefined floating-point data format in which data elements are input to the dot-product units. If the first data format is a higher precision data format than the second floating-point data format, the format conversion unit generates two or more data elements in the second floating-point data format.

### TECHNICAL FIELD

The present invention relates to tensor processing circuitry and a method performed by tensor processing circuitry.

### BACKGROUND

A neural processing unit (NPU) is a specialised hardware accelerator designed to enhanced performance of information processing apparatus, such as computers and mobile devices, when performing machine learning tasks. Unlike traditional CPUs or GPUs, NPUs are specifically designed to handle tensor (matrix) operations, which are prevalent in deep learning models.

Machine learning models may use floating point or other numerical values of different levels of precision and in different formats. However, it is expensive for a tensor processing unit to include dedicated hardware to support many different data formats that may need to be processed for different machine learning models.

Accordingly, there is a desire for a neural processing unit that includes tensor processing circuitry that can efficiently handle tensor processing operations for different data formats.

### SUMMARY

According to a first aspect of the present invention, there is provided tensor processing circuitry comprising: a plurality of dot-product units, each of which is configured to perform a multiply accumulate operation; a format conversion unit configured to convert the format of a first data element before processing by the plurality of dot product units, wherein the format conversion unit is configured to: convert the first data element from a first data format to one or more data elements in a second floating point data format, the first data format being one of a plurality of data formats supported by the tensor processing circuitry and the second data format being a predefined floating-point data format in which data elements are input to the dot-product units; in a case that the first data format is a higher precision data format than the second floating-point data format, generate two or more data elements in the second floating-point data format; and output the one or more data elements in the second floating-point data format to the plurality of dot-product units for multiplication with a second data element.

According to a second aspect there is provided a method performed by a tensor processing circuitry comprising: converting, by a format conversion unit, a first data element from a first data format to one or more data elements in a second floating point data format, the first data format being one of a plurality of data formats supported by the tensor processing circuitry and the second data format being a predefined floating-point data format in which data elements are input to the dot-product units, wherein, in a case that the first data format is a higher precision data format than the second floating-point data format, the format conversion unit generates two or more data elements in the second floating-point data format; and outputting the one or more data elements in the second floating-point data format to a plurality of dot-product units for multiplication with a second data element.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing an information processing apparatus comprising a plurality of processors, including a CPU and an NPU;

FIG. 2 shows a sequence of units included in tensor processing circuitry;

FIG. 3 is a table showing different data element formats supported by the tensor processing circuitry;

FIGS. 4a and 4b are a schematic diagram illustrating processing by tensor processing circuitry to multiply and accumulate two data elements;

FIG. 5 is a diagram illustrating different areas of elements that are read out from a tensor in a case that a transpose is performed on data elements by the tensor processing circuitry;

FIG. 6a is a table illustrating data element formats for zero, infinity, and not-a-number values;

FIG. 6b is a table illustrating logic for identifying zero, infinity, and not-a-number values and associated two-bit codes that are added to data elements by a data conversion unit when converting to a regularized format;

FIG. 7 is a schematic diagram illustrating components of an information processing apparatus; and

FIG. 8 illustrates a a system comprising at least one packaged chip.

### DETAILED DESCRIPTION

As will be described further below, an information processing apparatus may comprise a processor in the form of a central processing unit, CPU, and a processor in the form of a tensor processing unit, TPU. The tensor processing unit may comprise tensor processing circuitry that can process a plurality of different formats of input data elements to perform multiply-accumulate operations, while using relatively low surface area.

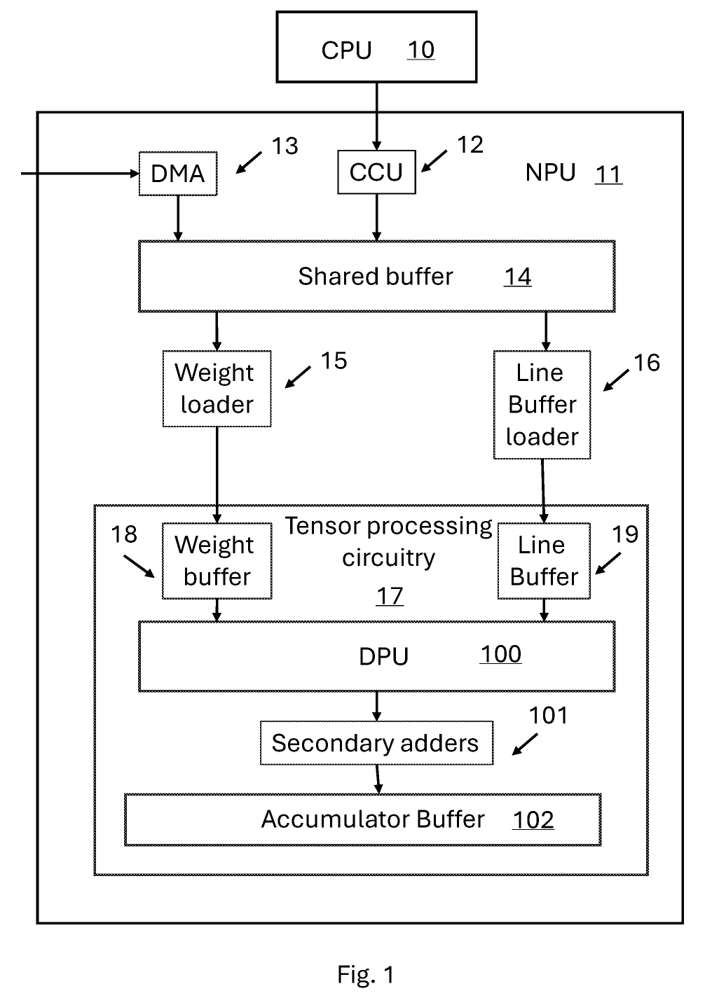

FIG. 1 shows components within an information processing apparatus. A central processing unit, CPU, 10 is connected to a neural processing unit, NPU, 11. Commands may be sent from the CPU 10 and received at a central control unit, CCU, 12 of the NPU 11.

A direct memory access unit, DMA, 13 is configured to operate under control of the CCU 12. The DMA 13 may read data from an external memory into a shared buffer 14 within the NPU 11. In some instances, the data may include weight values and data elements from a tensor comprising feature map data of a machine learning model. In other instances, the data may include data elements from two tensors, wherein the data elements in the two tensors are to be multiplied together.

A weight loader 15 and line buffer loader 16 of the NPU 11 are configured to transfer data from the shared buffer 14 to tensor processing circuitry 17. More particularly, the weight loader 15 is configured to transfer weight values from the shared buffer 14 to a storage in the form of a weight buffer 18. The line buffer loader 16 is configured to transfer data elements from the shared buffer 14 to a storage in the form of a line buffer 19. As will be explained in more detail below, the line buffer 19 and weight buffer 18 each include a format conversion unit. In other implementations, the line buffer 19 and weight buffer 18 may be connected to a common format conversion unit.

The tensor processing circuitry 17 is configured so that data elements weight values and/or data elements from a tensor are respectively loaded from the weight buffer 18 and line buffer 19 and are input to a set of dot product units, DPU, 100. It is noted that, in the case of matrix multiplication, the weight buffer 18 may contain values other than weight values. In one example, the dot product units 100 may be an array of 1024 dot product units, each of which is configured to perform eight multiply accumulate operations per cycle of the tensor processing circuity. The hardware in each dot product unit includes an 8-bit by 8-bit multiplier and a primary accumulator. A cycle of the tensor processing circuitry 17 (and other components in the NPU 11) is determined by a clock signal from a clock generator (not shown).

Values that have been multiplied and accumulated by the dot product units 100 may be further accumulated in a set of secondary adders 101. Finally, the accumulated data may be stored in an accumulator buffer 102. Data stored in the accumulator buffer 102 may be subject to further processing, such as processing by a vector processing unit. For example, the vector processing unit may optionally perform one of: add a bias, scale, apply an activation function, and format-convert to various different supported output formats. After processing by the tensor processing circuitry and/or vector processing unit, the processed data elements may be written back to the shared buffer 14. Details of any further processing are not relevant to the present disclosure and are not set out in detail.

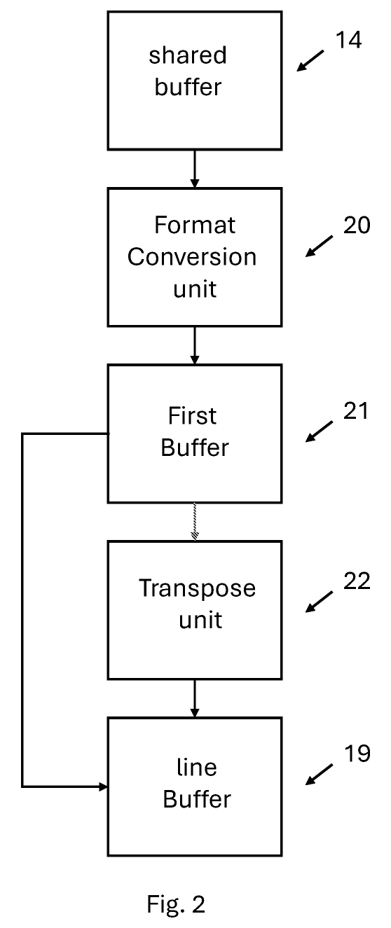

FIG. 2 is a schematic diagram showing in more detail processing of data elements between storage in the shared buffer 14 and processing by the dot product units 100. Similar processing may be performed regardless of whether data elements are eventually stored in the line buffer 19 or the weight buffer 18. Accordingly, the same description applies to processing both between the shared buffer 14 and the line buffer 19 and between the shared buffer 14 and the weight buffer 18 and is not repeated. At the start of the processing, data elements are stored in the shared buffer 14 as described above. The data elements may be read from the shared buffer 14 and converted to a regularized format by a format conversion unit as will be described in more detail below. The regularized data elements are stored in a storage in the form of first buffer 21. Optionally, in some implementations, a transpose unit 22 may be provided to transpose the regularized data elements. After transpose processing by the transpose unit 22, the transposed data elements may be stored in the line buffer 19. If the data elements are not processed by the transpose unit 22, they may bypass the transpose unit as illustrated.

In FIG. 2 the transpose unit 22 is shown located between a first buffer 21 and a line buffer 19. In other implementations, the transpose unit 22 may be directly connected to either the format conversion unit 20 or the dot product units 100 and the first buffer 21 may be omitted.

It is noted that, as shown in FIG. 2 and described above, that the transpose unit 22 is provided in-line between the shared buffer 14 and the line buffer 19. An alternative is to have one or two transpose units (one for the left/weight tensor data elements and/or one for the right/input feature map elements) provided separately. These transpose units would read data elements from the shared buffer 14, transpose the data elements, write the transposed data elements back to the shared buffer 14. The transposed data elements would subsequently be read to the dot-product units 100. The in-line approach described in connection with FIG. 2 avoids overhead and a round trip to and from the shared buffer 14 associated with this alternative approach. There would also be an extra cost in shared buffer storage needed to store values being transposed that is avoided by the approach set out in connection with FIG. 2.

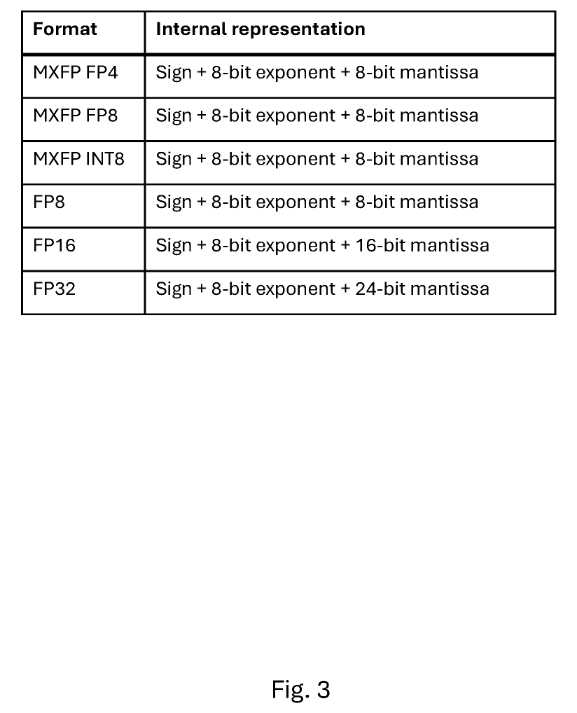

The format conversion unit 20 is configured to receive data elements, each data element being in one of a plurality of different data formats (which is an example of a first data format). FIG. 3 is a chart showing data formats supported as inputs to the format conversion unit 20 according to one embodiment.

In this example, the format conversion unit 20 supports three MXFP formats (4-bit floating point, 8-bit floating point, and 8-bit integer) and three floating-point formats: FP8, FP16, and FP32. Here is it noted that the size of the mantissa is in each case a multiple of 8-bits. If a mantissa of a format is not a multiple of 8-bits (e.g. FP4) then it is rounded up to the nearest 8-bits. Accordingly, although, FP16 only requires 10 bits (11 bits including the implicit bit) for the mantissa this is rounded up to 16.

MXFP data formats are compressed data formats defined by the Open Compute Project under the OCP Microscaling Formats (MX) Specification. The details of these particular formats are not relevant for the present disclosure beyond the number of bits represented by the format. In practice any incoming number format could be supported.

The format conversion unit 20 is configured to convert a plurality of supported formats, such as for example those illustrated in FIG. 3, and to convert them to a single format (which is an example of a second floating point data format), which will be referred to as the regularized format. In the present example, the regularized format is a modified floating-point format with a sign, an 8-bit exponent, and an 8-bit mantissa. In this example, the implicit bit to the left of the binary point in the mantissa is also stored as part of the regularized format. Accordingly, the regularized format for each byte may comprise the sign bit, an 8-bit exponent and 8-bits of the mantissa. For the high byte, the 8-bits of the mantissa may be formed of the implicit bit and 7-bits of the mantissa. For other bytes, the 8-bits of the mantissa do not include the implicit bit. The implicit bit is 1 for normal numbers and 0 for subnormal numbers. As explained further below, the regularized format also includes additional bits to indicate zero, infinity, and not-a-number (NaN). In other embodiments or in particular situations, the additional bits may be generated later in the processing of the data elements in the regularized format after the conversion by the format conversion unit 20.

For formats in which the number of incoming bits in the mantissa is equal to the number of bits in the mantissa of the regularized format, there is a one-to-one correspondence between the number of incoming data elements received at the format conversion unit 20 and the number of elements output by the format conversion unit 20. The format conversion unit 20 comprises logic for converting between the input format and the regularized format.

In a case in which the input format has a higher precision than the regularized format, the format conversion unit 20 is configured to perform a conversion such that a single input data element is converted to a plurality of data elements in the regularized data format. For example, two or three data elements (referred to hereinafter as ‘bytes’) may be generated from a single input data element. To give an example, FP32 includes a sign bit, 8 exponent bits and 24 mantissa bits. All data elements in the regularized format may be generated by the format conversion unit 20 from an input format in a single cycle.

### If:

### FP32 data element

### Sign: 0

### Exponent: 01111011 (equivalent to 123-127=-4)

### Mantissa: 100001000110010010001000

### Equivalent value: 0.0646449

This single FP32 data element may be split into three regularized bytes. A bias of 127 is applied to the exponent. Accordingly, in the regularized format the FP32 value is split as follows:

### Byte 1:

### Sign: 0

### Exponent: 01111011 (equivalent to 123-127 = -4)

### Mantissa: 10000100

### Equivalent value: 0.0644531

### Byte 2:

### Sign: 0

### Exponent: 01110011 (equivalent to 115 -127 = -12)

### Mantissa: 01100100

### Equivalent value: 0.0001907

### Byte 3:

### Sign: 0

### Exponent: 01101011 (equivalent to 107-127= -20)

### Mantissa: 10001000

### Equivalent value: 0.0000010

It can be seen from the above, that the exponent for the Byte 1 is unchanged, the exponent for Byte 2 has its exponent reduced by 8 and the exponent for Byte 3 has its exponent reduced by 16 to account for the positions when the mantissa is broken up into three bytes. In the embodiment, the exponents aren’t adjusted by the format conversion unit 20. Instead, as will be explained further below, the exponents are adjusted at the dot product output stage, which is logically equivalent. However, in some implementations the exponents may be adjusted upon conversion. The values of the three bytes add up to the original value (i.e. 0.0646448 = 0.0644531+ 0.0001907+ 0.0000010).

Accordingly, the FP32 data element can be said to be split into high (byte 1), mid (byte 2) and low (byte 3) bytes.

A similar approach can be adopted for FP16, which is split into two bytes, a high byte and a low byte. The low byte has its exponent reduced by 8 to account for the shift in bit positions in the mantissa.

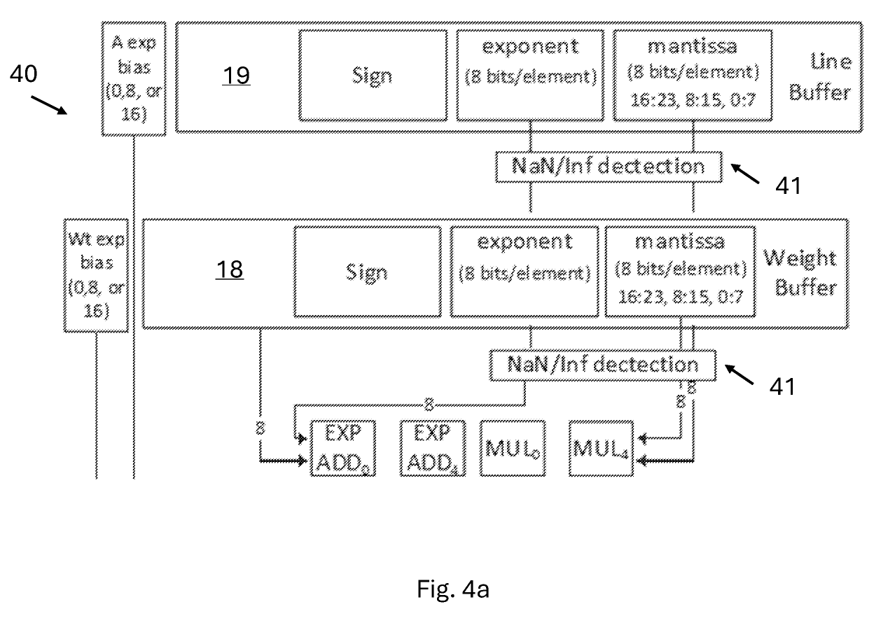

FIGS. 4a and 4b are a schematic illustration of processing of the bytes after converting to the regularized format. The line buffer 19 stores regularized bytes with a sign, exponent (8-bits) and mantissa of 8-bits per data element. As indicated above, for FP32 the first eight bits (0:7) form one byte, the second eight bits (8:15) for the second byte, and the third eight bits (16:23) form the third byte.

Similarly, the weight buffer 18 includes regularized bytes with a sign, exponent (8-bits) and mantissa of 8-bits per data element. As indicated above, the first eight bits (0:7) form one byte, the second eight bits (8:15) form the second byte, and the third eight bits (16:23) form the third byte.

A bias for each of the values, to shift the different bytes by 0, 8 or 16 as required, is shown at 40. A NaN/infinity detection step is shown at 41. This will be described further below.

The regularized data elements from the line buffer 19 and weight buffer 18 are fed into an array of dot product units 100 that are shown partially in FIG. 4a and partially in FIG. 4b. The dot product units are shown represented by adders and multipliers. Multiplication of the input data elements proceeds in two parts. In a first part, the exponents of the two data elements input to the dot product units 100 are added together. In a second part, the mantissa strings of the two data elements are multiplied together in the multipliers. As illustrated in FIG. 4b, the exponents are then aligned (with appropriate biases being applied to account for separation of higher precision data elements into a plurality of bytes) and then the values are accumulated (added together) in a primary accumulator 42 of the dot product unit 100.

In one particular implementation, inputs to the dot product units 100 in each cycle are of a single byte type, e.g. high, mid or low, for bytes generated from FP32. The exponents are added together for each pair of multiplier inputs and then an alignment step is performed to align the mantissas of the multiplier outputs before performing a (8-input) floating point add. The result is a single exponent and mantissa for the sum. The exponent of the sum is adjusted according to which byte types (e.g. low, mid, high) were processed in that cycle for both inputs to the multipliers. For example, one input to a multiplier might be a high byte and the other might be a middle byte of a data element. The adjusted floating-point number is added into the primary accumulator 42. In these implementations, the inputs from the weight buffer 18 are all of the same type, e.g. all high, all mid, or all low bytes and all the multiplier inputs from the line buffer 19 are of the same type, e.g. all high, all mid, or all low bytes in a given cycle. Accordingly, the exponent adjustments can be factored out until after summing the multiplier outputs without affecting the results.

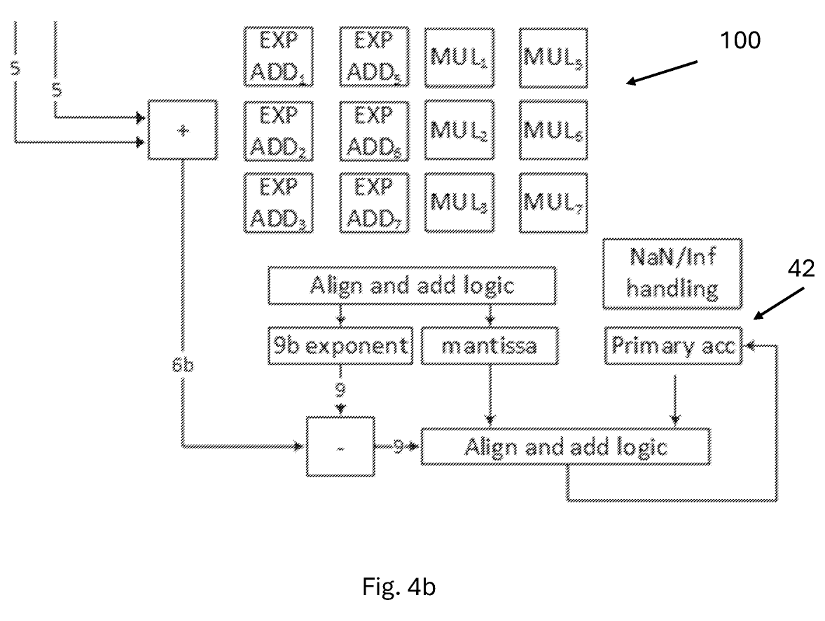

As noted in connection with FIG. 2, in a case that the tensor processing circuitry 17 is performing a matrix multiplication, it may be appropriate to perform a transpose of the data elements. In some implementations, a predetermined number of data elements are loaded per cycle into the line buffer 19 or weight buffer 18 in what is referred to as a block. When processing weight data and feature map data for a machine learning model the transpose unit 22 may be configured to “pass through” the data without the transpose unit 22 performing any transposition as discussed in connection with FIG. 2. However, the block may be transposed when performing a matrix multiplication such that the appropriate elements are fetched to be multiplied together. FIG. 5 illustrates two blocks of data to illustrate the transpose. In a pass-through mode the transpose unit 22 may load data elements as illustrated at the top of FIG. 5 with data elements loaded in row major order. In a case that a transpose is to be performed, the transpose unit 22 may load data elements as shown at the bottom of FIG. 5 in column major order. The loaded data elements are then transposed within the transpose unit 22 using multiplexers that transpose the row and column dimensions based on the position of data elements within the matrix being processed. As expected, data elements on the diagonal of the matrix are passed through without adjustment.

As noted above, zero/NaN/infinity detection is performed at various points. At the time of that the data elements are converted by the format conversion unit 20 into the regularized format, the input data element is examined to determine if the input data element is one of: zero, infinity, and not-a-number. A 2-bit code is computed per element and sent along with the sign, 8-bit exponent, and one 8-bit mantissa to the DPU 100. The 2-bit code may form part of the regularized data format. This allows detection of zero, infinity, and not-a-number based on a single byte/data element in the regularized format and does not require the tensor processing circuit 17 to keep track of different bytes of high precision data elements or to examine all the bytes of such high precision data elements to establish zero, infinity, and not-a-number value.

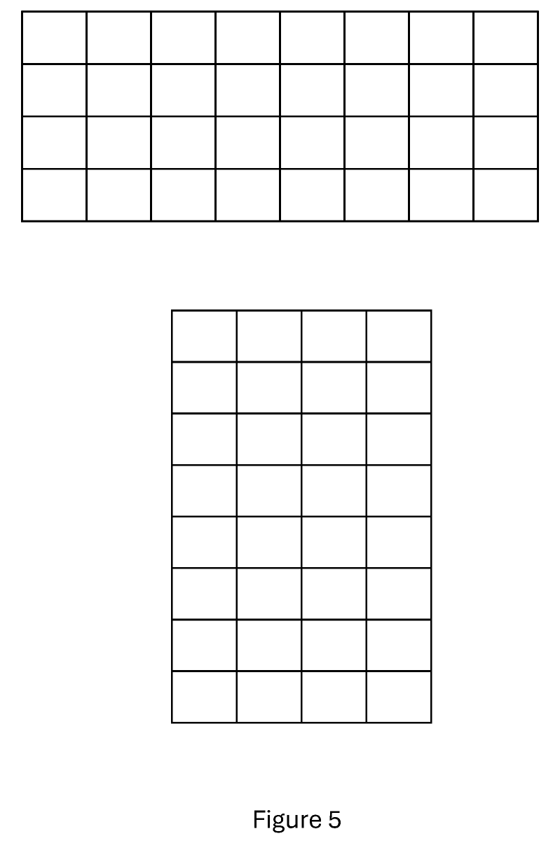

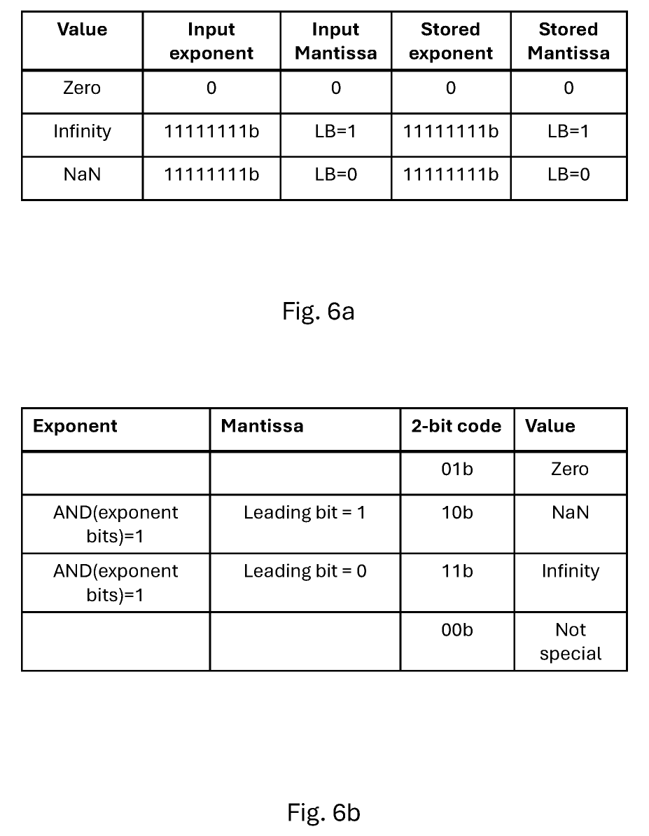

FIG. 6a shows the input exponent and stored exponent (stored in the weight buffer 18 or line buffer 19) for zero, infinity, and non-a-number (NaN) values. Zero has 0 on the input exponent and mantissa and is stored in the same format.

An input value of infinity is represented by an exponent of 11111111 and the mantissa is selected to have a leading bit of 1. The value infinity is stored with an exponent of 11111111 and a leading 1 in the mantissa.

Not-a-number is used to represent data elements that cannot be represented, such as divisions by zero or operations that would produce a complex number as a result. These are represented by 11111111 in the input exponent and a leading bit of 0 in the mantissa. The data element stored in the line buffer or weight buffer is all 1 for the exponent and a leading 0 for the mantissa.

FIG. 6b indicates detection of data elements representing zero, NaN, infinity, and not special numbers (which covers other normal data values). As noted in connection with FIG. 6a, zero is indicated by all zeros in the exponent and the mantissa in the usual manner for floating point numbers. Zero is given a two-bit code of 01 when converted to the regularized format by the format conversion unit 20.

Not-a-number (NaN) is represented by all 1’s in the exponent. Accordingly, an AND of all the exponent bits will produce a result of 1. The stored mantissa for NaN includes a leading 0. NAN is given a two-bit code of 10 when converted to the regularized format by the format conversion unit 20.

Infinity is represented by all 1’s in the exponent. Accordingly, an AND of all the exponent bits should produce a result of 1. The stored mantissa for NaN includes a leading bit of 1. Infinity is given a two-bit code of 11 when converted to the regularized format by the format conversion unit 20.

Other numbers (not special) are detected as normal floating point numbers Not special data elements are given a two-bit code of 00 when converted to the regularized format by the format conversion unit 20.

It is noted that a subnormal data element (an example of a not special data element), where the original number’s exponent is 0, is handled by the format conversion unit 20 by inserting a 0 leading bit in the mantissa instead of a 1. Accordingly, a data element output from the format conversion unit 20 that is subnormal will be 0.mmmmmmm instead of 1.mmmmmmm. After the format conversion unit 20 subnormal data elements are handled like any other non-special number.

The dot product units 100 are configured to identify data elements that are NaN or infinity based on the two-bit codes. If an input number is NaN, the primary accumulator is forced to NaN. Similarly, if a multiplier is instructed to multiply zero and infinity, the output is forced to NaN.

In a case that a multiplier in the dot product units 100 detects that one or both inputs are infinity, the output of the multiplier is set to infinity.

By providing two-bit codes in the regularized format, the dot product units 100 can quickly and easily handle zero, infinity and NaN values. Further, when a higher precision number is split into multiple bytes, there is no need to examine all bytes to identify zero, infinity and NaN values.

The tensor processing circuitry 17 described above allows higher precision data elements to be processed using tensor processing circuitry 17 designed to handle lower precision data elements in the regularized format. This is achieved by splitting the higher precision format data elements into a plurality of regularized format data elements as described above. As each of the regularized data elements needs to be processed through the dot product units 100 separately, this causes higher precision data elements to be processed more slowly than using dedicated hardware. On the other hand, higher precision data elements may take a longer time to fetch from a storage, such as shared buffer 14. Accordingly, while the approach described is slower to process through the dot product units 100, the extent of the slow down depends on what would otherwise be the rate limiting step in the processor.

In one example, a matrix multiplication between two FP32 data elements would result in each data element being split into three regularized data elements. To complete the multiplication, a permutation circuitry implements control so that each of the nine combinations of the high, mid, and low byte of each FP32 data element are input into the dot product units 100 for multiplication and accumulation. The combinations are high-high, high-mid, mid-high, mid-mid, mid-low, low-mid, low-low, low-high, and high-low.

The tensor processing circuitry 17 may be configured to perform multiplication and accumulation of different combinations of data elements having different precisions. For example, FP16 may be broken down into two bytes: high and low. The permutation circuitry may control multiplication between data elements having different precisions. For example, an FP32 data element (high, mid, low bytes) multiplied by a FP16 data element may cause input of the following combinations to the dot product units 100: high-high, mid-high, low-high, high-low, mid-low, low-low.

As mentioned above, the dot product units 100 include 8-bit by 8-bit multipliers. To perform multiplication with FP32 data elements, a 24-bit by 24-bit multiplier would natively be required. Accordingly, the tensor processing circuitry 17 allows multiple different formats to be supported without needing to provide a range of different circuits needed for performing operations with each of the different data formats. This reduces the circuit size and may save power consumption.

The combinations of bytes described above may be input to a single dot product unit 100 so that the value obtained in the primary accumulator is the accumulated value corresponding to the original input higher precision data element. As explained above, the dot product units 100 only need to support data elements in the regularized format. The regularized format may be selected to have an exponent that is wide enough to match the largest exponent of a supported format incoming format.

The above embodiments are to be understood as illustrative examples of the invention. Further embodiments of the invention are envisaged. For example, in the examples above, the dot product units 100 are agnostic to the data elements received. That is to say that the exponents of the data elements in the regularized format are adjusted for each byte before they reach the dot product units. In other embodiments, an adjustment to the exponents could be applied at the primary accumulator 42 within the dot product unit. If the number of bytes is known, an adjustment may be made to each multiplied value prior to accumulation by virtue of the commutative property of multiplication.

The examples above illustrate the case in which the regularized format has an 8-bit mantissa. It is noted that this is for illustration only. Other mantissa sizes are possible. For example, the mantissa could be split to a regularized format that has a 5-bit mantissa. This would result in higher precision formats being split into more regularized data elements and thereby increase the number of cycles required to complete the multiply-accumulate processing.

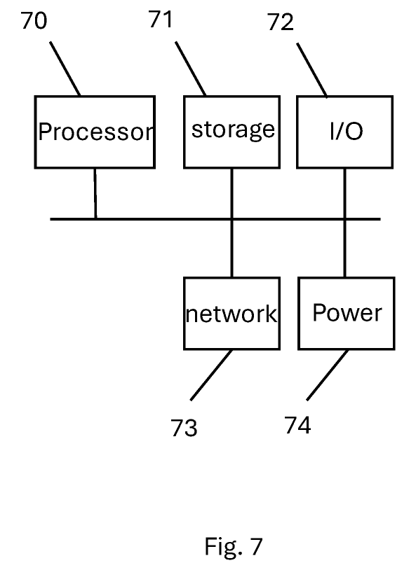

FIG. 7 is a schematic diagram showing hardware of an information processing apparatus. The information processing unit may comprise one or more processor 70, a storage 71, an I/O unit 72, a network unit 73, and a power unit 74. Other components may be present but not shown as is well known in the art.

The one or more processor 70 may include the combination of the CPU 10 and NPU 11 described above. The one or more processors 70 may be configured to perform computations. The processor 70 may consist of one or more a central processing unit (CPU), a graphics processing unit (GPU) and a neural processing unit (NPU). The storage unit 71 may include both volatile (RAM) and non-volatile (ROM, SSD, HDD) memory components. The storage unit 71 may store both the instructions to be executed by the processor and the data on which these instructions operate. The Input/Output Interfaces unit 72 allows the apparatus to communicate with external devices. Input interfaces may include components like a keyboard, mouse, or touchscreen for user interaction, while output interfaces may include a display, printer, or speakers. The network unit 73 may enable the apparatus to connect to networks (e.g., LAN, WAN, Wi-Fi, Bluetooth, etc.) for data exchange. The network unit 73 may include wired or wireless communication modules. The power unit 74 may provide the necessary power for all components of the apparatus. The power unit 74 may be connected to an external power source or include an internal battery for portable use.

### Other aspects

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

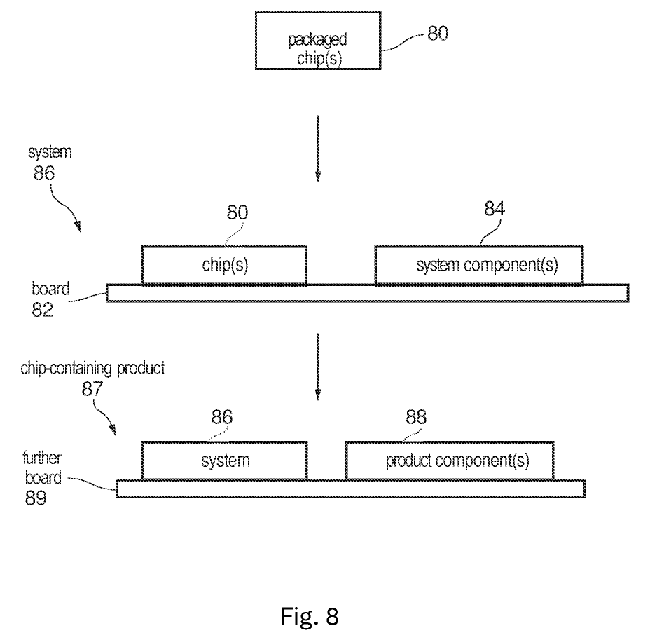

As shown in FIG. 8, one or more packaged chips 80, with the processor described above implemented on one chip or distributed over two or more of the chips, are manufactured by a semiconductor chip manufacturer. In some examples, the chip product 80 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 80 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 80 are assembled on a board 82 together with at least one system component 84 to provide a system 86. For example, the board may comprise a printed circuit board. The board substrate may be made of any of a variety of materials, e.g. plastic, glass, ceramic, or a flexible substrate material such as paper, plastic or textile material. The at least one system component 84 comprise one or more external components which are not part of the one or more packaged chip(s) 80. For example, the at least one system component 84 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 87 is manufactured comprising the system 86 (including the board 82, the one or more chips 80 and the at least one system component 84) and one or more product components 88. The product components 88 comprise one or more further components which are not part of the system 87. As a non-exhaustive list of examples, the one or more product components 88 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 87 and one or more product components 88 may be assembled on to a further board 89.

The board 82 or the further board 89 may be provided on or within a device housing or other structural support (e.g. a frame or blade) to provide a product which can be handled by a user and/or is intended for operational use by a person or company.

The system 86 or the chip-containing product 87 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further embodiments

A further embodiment provides tensor processing circuitry comprising a plurality of dot-product units, each of which is configured to perform a multiply accumulate operation. A format conversion unit is configured to convert the format of a first data element before processing by the plurality of dot product units. The format conversion unit is configured to convert the first data element from a first data format to one or more data elements in a second floating point data format. The first data format is one of a plurality of data formats supported by the tensor processing circuitry and the second data format is a predefined floating-point data format in which data elements are input to the dot-product units. In a case that the first data format is a higher precision data format than the second floating-point data format, the format conversion unit generates two or more data elements in the second floating-point data format. The format conversion unit outputs the one or more data elements in the second floating-point data format to the plurality of dot-product units for multiplication with a second data element.

In a case that the format conversion unit generates two or more data elements in the second data format from the first data element, the tensor processing circuitry may be further configured to: separately input the two or more data elements to a dot product unit of the plurality of dot product units with the second data element for multiplication and accumulation. The data conversion unit may be configured to adjust an exponent of one or more of the two or more data elements.

The format conversion unit may be configured to generate the two or more data elements in the second floating-point data format.

The second floating-point data format may have an exponent that is at least as long as the exponent in the first data format. In a case that the first data format is a higher precision data format than the second floating-point data format, the format conversion unit may be configured to generate two or more data elements in the second floating-point data format by splitting the mantissa of the first data format.

The format conversion unit may be configured to generate two or more data elements in the second floating-point data format that sum together to a value of the first data element in the first data format.

The two or more first data elements in the second floating-point data format generated by splitting the mantissa may have at least a first type and a second type depending upon the portion of the split mantissa. The plurality of dot product units may be configured to receive first data elements in the second floating point data format of only one of the first type and the second type in any one cycle of the tensor processing circuitry.

The format conversion unit may be configured to: convert the second data element from a third data format to one or more data elements in the second floating point data format, the third data format being one of a plurality of data formats supported by the tensor processing circuitry. In a case that the third data format is a higher precision data format than the second floating-point data format, the data conversion unit may generate two or more data elements in the second floating-point data format.

The tensor processing circuitry may comprise permutation circuitry configured to input to the plurality of dot-product units each possible combination of pairs of data elements that takes one of the two or more data elements in the second floating-point data format representing the first data element and one of the two or more data elements in the second floating-point data format representing the second data element.

The first data element may be a data element from a feature map of a machine learning model. The second data element may be a weight from the machine learning model.

In other implementations, the first data element may be one of a plurality of data elements from a first tensor. The second data element may be one of a plurality of data elements from a second tensor. The tensor processing circuitry may further comprise transpose circuitry configured to transpose at least one of: the plurality of data elements from the first tensor and the plurality of data elements from the second tensor. The plurality of dot-product units may be configured to multiply the plurality of data elements from the first tensor and the plurality of data elements from the second tensor.

The transpose circuitry may be connected inline between the format conversion unit and the plurality of dot product units. The transpose circuitry may be connected inline between a storage and the plurality of dot product units.

The transpose may be operable to perform a transpose for neither, one, or both of the plurality of data elements from the first tensor and the plurality of data elements from the second tensor.

The format conversion unit may be configured to: detect if the first data element has a data element type that is at least one of: zero, infinity, and not a number. The format conversion unit may be configured to add a code to the one or more data elements in the second floating point data format in a case that one of the data element types is detected.

A second further embodiment may provide a system comprising: the tensor processing circuitry of the first further embodiment, implemented in at least one packaged chip; at least one system component; and a board, wherein the at least one packaged chip and the at least one system component are assembled on the board.

The system may be assembled on a further board with at least one other product component.

A third further embodiment may provide a non-transitory computer-readable medium having stored thereon computer-readable code for fabrication of the tensor processing circuitry of the first further embodiment.

A fourth further embodiment may provide a method performed by a tensor processing circuitry comprising: converting, by a format conversion unit, a first data element from a first data format to one or more data elements in a second floating point data format, the first data format being one of a plurality of data formats supported by the tensor processing circuitry and the second data format being a predefined floating-point data format in which data elements are input to the dot-product units, wherein, in a case that the first data format is a higher precision data format than the second floating-point data format, the format conversion unit generates two or more data elements in the second floating-point data format; and outputting the one or more data elements in the second floating-point data format to a plurality of dot-product units for multiplication with a second data element.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The following clauses form part of the description. The claims follow these clauses and are labelled as such.

1. Tensor processing circuitry comprising: a plurality of dot-product units, each of which is configured to perform a multiply accumulate operation; a format conversion unit configured to convert the format of a first data element before processing by the plurality of dot product units, wherein the format conversion unit is configured to: convert the first data element from a first data format to one or more data elements in a second floating point data format, the first data format being one of a plurality of data formats supported by the tensor processing circuitry and the second data format being a predefined floating-point data format in which data elements are input to the dot-product units; in a case that the first data format is a higher precision data format than the second floating-point data format, generate two or more data elements in the second floating-point data format; and output the one or more data elements in the second floating-point data format to the plurality of dot-product units for multiplication with a second data element.

2. Tensor processing circuitry according to clause 1, wherein, in a case that the format conversion unit generates two or more data elements in the second data format from the first data element, the tensor processing circuitry is further configured to: separately input the two or more data elements to a dot product unit of the plurality of dot product units with the second data element for multiplication and accumulation, and adjust an exponent of one or more of the two or more data elements.

3. Tensor processing circuitry according to clause 1 or clause 2, wherein the format conversion unit is configured to generate the two or more data elements in the second floating-point data format.

4. Tensor processing circuitry according to any preceding clause wherein the second floating-point data format has an exponent that is at least as long as the exponent in the first data format, wherein in a case that the first data format is a higher precision data format than the second floating-point data format, the format conversion unit is configured to generate two or more data elements in the second floating-point data format by splitting the mantissa of the first data format.

5. Tensor processing circuitry according to clause 4, wherein the format conversion unit is configured to generate two or more data elements in the second floating-point data format that sum together to a value of the first data element in the first data format.

6. Tensor processing circuitry according to clause 4 or clause 5, wherein: the two or more first data elements in the second floating-point data format generated by splitting the mantissa have at least a first type and a second type depending upon the portion of the split mantissa; and the plurality of dot product units are configured to receive first data elements in the second floating point data format of only one of the first type and the second type in any one cycle of the tensor processing circuitry.

7. Tensor processing circuitry according to any preceding clause, wherein the format conversion unit is configured to: convert the second data element from a third data format to one or more data elements in the second floating point data format, the third data format being one of a plurality of data formats supported by the tensor processing circuitry; and in a case that the third data format is a higher precision data format than the second floating-point data format, generate two or more data elements in the second floating-point data format.

8. Tensor processing circuitry according to clause 7, further comprising permutation circuitry configured to input to the plurality of dot-product units each possible combination of pairs of data elements that takes one of the two or more data elements in the second floating-point data format representing the first data element and one of the two or more data elements in the second floating-point data format representing the second data element.

9. Tensor processing circuitry according to any preceding clause, wherein the first data element is a data element from a feature map of a machine learning model and the second data element is a weight from the machine learning model.

10. Tensor processing circuitry according to any preceding clause, wherein: the first data element is one of a plurality of data elements from a first tensor and the second data element is one of a plurality of data elements from a second tensor; the tensor processing circuitry further comprises transpose circuitry configured to transpose at least one of the plurality of data elements from the first tensor and the plurality of data elements from the second tensor; and the plurality of dot-product units are configured to multiply the plurality of data elements from the first tensor and the plurality of data elements from the second tensor.

11. The tensor processing circuitry of clause 10, wherein the transpose circuitry is connected inline between the format conversion unit and the plurality of dot product units.

12. The tensor processing circuitry according to any preceding clause, wherein the format conversion unit is configured to: detect if the first data element has a data element type that is at least one of: zero, infinity, and not a number; and to add a code to the one or more data elements in the second floating point data format in a case that one of the data element types is detected.

13. A system comprising: the tensor processing circuitry of any preceding clause, implemented in at least one packaged chip; at least one system component; and a board, wherein the at least one packaged chip and the at least one system component are assembled on the board.

14. A chip-containing product comprising the system of clause 13, wherein the system is assembled on a further board with at least one other product component.

15. A non-transitory computer-readable medium having stored thereon computer-readable code for fabrication of the tensor processing circuitry of any preceding clause.

16. A method performed by a tensor processing circuitry comprising: converting, by a format conversion unit, a first data element from a first data format to one or more data elements in a second floating point data format, the first data format being one of a plurality of data formats supported by the tensor processing circuitry and the second data format being a predefined floating-point data format in which data elements are input to the dot-product units, wherein, in a case that the first data format is a higher precision data format than the second floating-point data format, the format conversion unit generates two or more data elements in the second floating-point data format; and outputting the one or more data elements in the second floating-point data format to a plurality of dot-product units for multiplication with a second data element.

What is claimed is:

1. Tensor processing circuitry comprising:
a plurality of dot-product units, each of which is configured to perform a multiply accumulate operation;
a format conversion unit configured to convert the format of a first data element before processing by the plurality of dot product units, wherein the format conversion unit is configured to:
convert the first data element from a first data format to one or more data elements in a second floating point data format, the first data format being one of a plurality of data formats supported by the tensor processing circuitry and the second data format being a predefined floating-point data format in which data elements are input to the dot-product units;
in a case that the first data format is a higher precision data format than the second floating-point data format, generate two or more data elements in the second floating-point data format; and
output the one or more data elements in the second floating-point data format to the plurality of dot-product units for multiplication with a second data element.

2. Tensor processing circuitry according to claim 1, wherein, in a case that the format conversion unit generates two or more data elements in the second data format from the first data element, the tensor processing circuitry is further configured to:
separately input the two or more data elements to a dot product unit of the plurality of dot product units with the second data element for multiplication and accumulation, and
adjust an exponent of one or more of the two or more data elements.

3. Tensor processing circuitry according to claim 1, wherein the format conversion unit is configured to generate the two or more data elements in the second floating-point data format.

4. Tensor processing circuitry according to claim 1 wherein the second floating-point data format has an exponent that is at least as long as the exponent in the first data format, wherein in a case that the first data format is a higher precision data format than the second floating-point data format, the format conversion unit is configured to generate two or more data elements in the second floating-point data format by splitting the mantissa of the first data format.

5. Tensor processing circuitry according to claim 4, wherein the format conversion unit is configured to generate two or more data elements in the second floating-point data format that sum together to a value of the first data element in the first data format.

6. Tensor processing circuitry according to claim 4, wherein:
the two or more first data elements in the second floating-point data format generated by splitting the mantissa have at least a first type and a second type depending upon the portion of the split mantissa; and
the plurality of dot product units are configured to receive first data elements in the second floating point data format of only one of the first type and the second type in any one cycle of the tensor processing circuitry.

7. Tensor processing circuitry according to claim 1, wherein the format conversion unit is configured to:
convert the second data element from a third data format to one or more data elements in the second floating point data format, the third data format being one of a plurality of data formats supported by the tensor processing circuitry; and
in a case that the third data format is a higher precision data format than the second floating-point data format, generate two or more data elements in the second floating-point data format.

8. Tensor processing circuitry according to claim 7, further comprising permutation circuitry configured to input to the plurality of dot-product units each possible combination of pairs of data elements that takes one of the two or more data elements in the second floating-point data format representing the first data element and one of the two or more data elements in the second floating-point data format representing the second data element.

9. Tensor processing circuitry according to claim 1, wherein the first data element is a data element from a feature map of a machine learning model and the second data element is a weight from the machine learning model.

10. Tensor processing circuitry according to claim 1, wherein:
the first data element is one of a plurality of data elements from a first tensor and the second data element is one of a plurality of data elements from a second tensor;
the tensor processing circuitry further comprises transpose circuitry configured to transpose at least one of the plurality of data elements from the first tensor and the plurality of data elements from the second tensor; and
the plurality of dot-product units are configured to multiply the plurality of data elements from the first tensor and the plurality of data elements from the second tensor.

11. The tensor processing circuitry of claim 10, wherein the transpose circuitry is connected inline between the format conversion unit and the plurality of dot product units.

12. The tensor processing circuitry according to claim 1, wherein the format conversion unit is configured to:
detect if the first data element has a data element type that is at least one of: zero, infinity, and not a number; and
to add a code to the one or more data elements in the second floating point data format in a case that one of the data element types is detected.

13. A system comprising:
the tensor processing circuitry of claim 1, implemented in at least one packaged chip;
at least one system component; and
a board,
wherein the at least one packaged chip and the at least one system component are assembled on the board.

14. A chip-containing product comprising the system of claim 13, wherein the system is assembled on a further board with at least one other product component.

15. A non-transitory computer-readable medium having stored thereon computer-readable code for fabrication of the tensor processing circuitry of claim 1.

16. A method performed by a tensor processing circuitry comprising:
converting, by a format conversion unit, a first data element from a first data format to one or more data elements in a second floating point data format, the first data format being one of a plurality of data formats supported by the tensor processing circuitry and the second data format being a predefined floating-point data format in which data elements are input to the dot-product units, wherein, in a case that the first data format is a higher precision data format than the second floating-point data format, the format conversion unit generates two or more data elements in the second floating-point data format; and
outputting the one or more data elements in the second floating-point data format to a plurality of dot-product units for multiplication with a second data element.
